(19) United States
(12) Patent Application Publication
(10) Pub. No.: US 2009/0135206 A1
(43) Pub. Date: May 28, 2009

(54) Color management system with advance function module and color management process for display device

(76) Inventors: Chin-Lung Chen, Hsin-Chu (TW); Chi-Chin Chen, Hsin-Chu (TW); Chun-Chieh Wang, Hsin-Chu (TW); Po-Chin Huang, Hsin-Chu (TW)

Correspondence Address: HDLS Patent & Trademark Services, P.O. BOX 220746, CHANTILLY, VA, 20153-0746, US

(21) Appl. No.: 12/108,721

(22) Filed: Apr. 24, 2008

(30) Foreign Application Priority Data
Nov. 26, 2007 (TW) 096144773

(51) Int. Cl. G09G 5/10

(52) U.S. Cl. 345/690

(57) ABSTRACT

A color management system for display device includes a color management controller, a color sensor, and an advance function module configured to implement a process (a) or a process (b) applied to multiple PWM signals generated from the color management controller. Process (a) includes the steps of using a reset signal generated by and synchronized with an image signal, and a counter with special bit length and counting frequency to generate a reference signal synchronized with the image signal, and using the reference signal to synchronize the PWM signals with the image signal as output. Process (b) includes the steps of using a reset signal with special frequency and a counter with special bit length and counting frequency to generate multiple synchronized reference signals with respective different phases, and generating multiple synchronized PWM signals with respective different phases as output by the use of the reference signals.

### BACKGROUND

1. Technical Field

The present invention relates generally to display devices and, particularly to a color management system and a color management process for a display device.

2. Description of the Related Art

Nowadays, a light emitting diode (LED) color-mixing based liquid crystal display (LCD) device is generally configured with a color management system. The color management system is for generating pulse width modulation (PWM) signals to control optical characteristics such as chrominance and luminance of a LED light source of the LCD device, so as to regulate a color gamut and a luminance of the LC display device.

A conventional color management system includes a color management controller and a color sensor such as RGB three-color sensor. The color sensor detects values of chrominance and luminance of a light mixed from the light beams emitted from a three primary color (i.e., red, green and blue) LED light source. The color management controller processes the detected values of chrominance and luminance and generates PWM signals for compensating the differences between expected values and the detected values of chrominance and luminance as output. Thereafter, a LED driver of the LCD device generates corresponding driving currents, according to the PWM signals, to respectively control the optical characteristics of the three primary color LED light sources.

However, for the conventional color management system, in one aspect, the PWM signals outputted therefrom are non-synchronous with an image signal generated by the LCD device, which would result in the generation of a visible beat frequency disturbance when displaying gray-scale images, so that an image quality of the LCD device is degraded. In another aspect, it could not distinguish the PWM signals for respectively controlling the driving currents for the RGB three primary colors to have different phases, which would cause the generation of excessive instantaneous driving current; as a result, the life-span of components would be correspondingly shorten and the electromagnetic interference would be increased.

Therefore, what is needed is to provide a color management system for a display device, which can effectively eliminate the beat frequency disturbance and/or suppress the generation of excessive instantaneous driving current.

### BRIEF SUMMARY

The embodiments of the present invention are to provide a color management system for a display device; the color management system is capable of outputting PWM signals synchronized with an image signal of the display device and/or allowing the PWM signals for respectively controlling driving currents for primary color light beams emitted from a light source to have respective different phases.

The embodiments of the present invention are to further provide a color management process for a display device; the color management process can synchronize PWM signals outputted from a color management system of the display device with an image signal of the display device, so as to eliminate a beat frequency disturbance.

The embodiments of the present invention are to still further provide another color management process for a display device; the color management process can enable PWM signals for respectively controlling driving currents for primary color light beams emitted from a light source to have respective different phases, so as to suppress the generation of excessive instantaneous driving current such that the shorten of life-span of components can be avoid and the electromagnetic interference can be reduced.

In order to achieve the above-mentioned objects, a color management system for a display device, in accordance with an embodiment of the invention, is provided. The color management system is configured in a display device and for controlling an optical characteristic of a light source which can emit different color light beams. The color management system includes a color management controller, an advance function module and a color sensor. The color sensor is configured (i.e., structured and arranged) to detect a value of an optical parameter of a light beam emitted from the light source. The color management controller is configured to generate multiple PWM signals, according to the detected value of the optical parameter, for compensating a difference between expected value and the detected value of the optical parameter. The advance function module is configured to implement a process (a) or a process (b) applied to the PWM signals generated from the color management controller. Process (a) includes the steps of using an image signal of the display device to generate a reset signal; using the reset signal and a counter with a special bit length and a counting frequency to generate a reference signal synchronized with the image signal; using the reference signal to synchronize the PWM signals, generated from the color management controller, with the image signal so as to obtain multiple synchronized PWM signals; and outputting the synchronized PWM signals. Process (b) includes the steps of generating a reset signal with a special frequency; using the reset signal with special frequency and a counter with a special bit length and a counting frequency to generate multiple reference signals with respective different phases and synchronized with the reset signal; synchronizing the PWM signals, generated from the color management controller, respectively with the reference signals having respective different phases so as to obtain and output multiple synchronized PWM signals with respective different phases.

Further, a color management process for display device, in accordance with another embodiment of the invention, is provided. The color management process is executed in a color management system of a display device, the color management system including a color management controller. The color management process includes the steps of:

using an image signal of the display device to generate a reset signal synchronized with the image signal;

using the reset signal and a counter with a special bit length and a counting frequency to generate a reference signal synchronized with the image signal; and

using the reference signal to synchronize PWM signals, generated from the color management controller, with the image signal so as to obtain multiple synchronized PWM signals, and outputting the synchronized PWM signals.

Still further, a color management process for display device, in accordance with still another embodiment of the invention, is provided. The color management process is executed in a color management system of a display device, the color management system including a color management controller. The color management process includes the steps of:

using a reset signal with a special frequency and a counter with a special bit length and a counting frequency to generates multiple reference signals having respective different phases and synchronized with the reset signal; and

synchronizing multiple PWM signals, generated from the color management controller, respectively with the reference signals having respective different phases to generate multiple corresponding synchronized PWM signals with respective different phases as output.

In a preferred embodiment, the step of synchronizing the PWM signals respectively with the reference signals to generate the multiple synchronized PWM signals with respective different phases includes the sub-steps of: using a first counter with the special bit length and the counting frequency to calculate a duty value of a special one of the PWM signals generated from the color management controller; employing one of the reference signals corresponding to the special one of the PWM signals and synchronized with the reset signal to trigger a second counter with the special bit length and the counting frequency to generate a corresponding one of the synchronized PWM signals, the calculated duty circle being employed as a reference count value for the second counter to set a duty circle of the corresponding one of the synchronized PWM signals same as that of the special one of the PWM signals; and repeating the above-described sub-steps so as to generate the multiple synchronized PWM signals with respective different phases as output.

In a further preferred embodiment, the reset signal with a special frequency is a signal synchronized with an image signal of the display device and generated by the use of the image signal.

Due to the fact that the present color management system is configured with the advance function module, the advance function module is capable of synchronizing the PWM signals outputted from the present color management system with an image signal of the display device and/or allowing the PWM signals respectively for controlling driving currents for primary color light beams emitted from a light source to have respective different phases, so that the visible beat frequency disturbance can be effectively eliminate and thus an image quality of the display device is improved, and/or suppress the generation of excessive instantaneous driving current to avoid the shorten of life-span of components and reduce the electromagnetic interference.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, partial function block diagram of a display device, in accordance with an embodiment of the present invention.

FIG. 2 shows illustrative timing diagrams for generating a reset signal RESET synchronized with the V-sync.

FIG. 3 shows illustrative timing diagrams for generating a reference signal Output_N by the use of the reset signal RESET of FIG. 2, in accordance with a first embodiment of the present invention.

FIG. 4 shows an illustrative flow chart for generating the reference signal Output_N of FIG. 3.

FIG. 5 shows illustrative timing diagrams for synchronizing a PWM signal PWM_I with the V-sync image signal by the use of the reference signal Output_N of FIG. 3, so as to generate a synchronized PWM signal PWM_O.

FIG. 6 shows an illustrative flow chart of calculating a duty circle of the PWM signal PWM_I of FIG. 5.

FIG. 7 shows an illustrative flow chart of duplicating the PWM signal PWM_I as the PWM signal PWM_O synchronized with the V-sync, by the use of the reference signal Output_N, in accordance with the first embodiment of the present invention.

FIG. 8 shows illustrative timing diagrams for generating synchronized reference signals Output_R, Output_G and Output_B having respective different phases, by the use of the reset signal RESET of FIG. 2, in accordance with a second embodiment of the present invention.

FIG. 9 shows an illustrative flow chart for generating the synchronized reference signals Output_R, Output_G and Output_B of FIG. 8.

### DETAILED DESCRIPTION

In the following detailed description of the preferred embodiments, reference is made to the accompanying drawings which form a part hereof, and in which is shown by way of illustration special embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

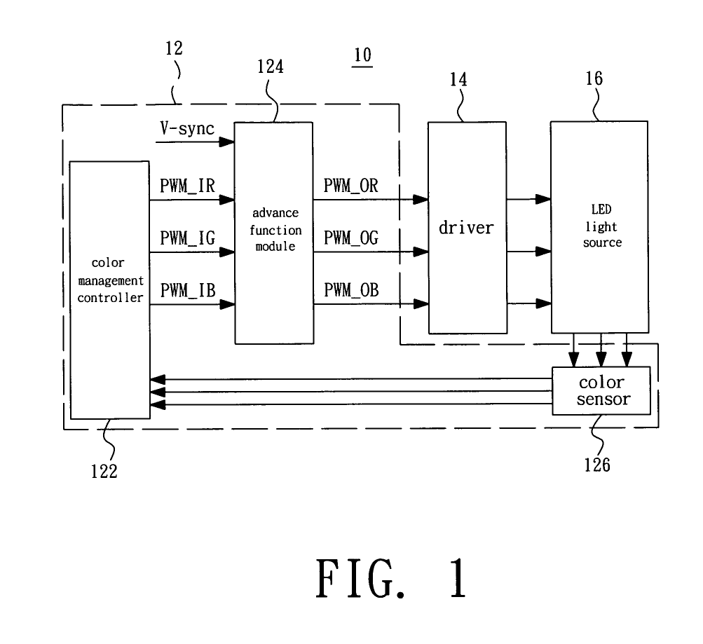

Referring to FIG. 1, a color management process for a display device 10, in accordance with a present embodiment is provided. The color management process is implemented/executed in a color management system 12 of the display device 10. The display device 10 can be a multi-color mixing based (e.g., three-color LEDs mixing based) liquid crystal display (LCD) device, for example, a color filter LCD or a color filter-less field sequential LCD device. The present display device 10 includes the color management system 12, a driver 14 and a light beam emitting diode (LED) light source 16. The color management system 12 includes a color management controller 122, an advance function module 124 and a color sensor 126 such as three-color sensor. The advance function module 124 and the color management controller 122 can be integrated into one unit.

In operation, the color sensor 126 detects a value(s) of an optical parameter(s) such as chrominance and/or luminance of a light beam mixed from three primary color light beams emitted from red (R), green (G) and blue (B) LEDs of the LED light source 16, and sends the detected value(s) to the color management controller 122 for process. The color management controller 122 generates multiple PWM signals PWM_IR, PWM_IG and PWM_IB for three RGB primary color light beams, the PWM signals are for compensating a difference between expected value(s) and the detected value(s) of the optical parameter(s). Thereafter, the PWM signals PWM_IR, PWM_IG and PWM_IB will be outputted into the advance function module 124. The advance function module 124 implements a process (a) or a process (b) applied to the received PWM signals PWM_IR, PWM_IG and PWM_IB, so as to output corresponding synchronized PWM signals PWM_OR, PWM_OG and PWM_OB to the driver 14. The driver 14 generates corresponding driving currents, according to the synchronized PWM signals PWM_OR, PWM_OG and PWM_OB, to respectively control the RGB three primary color LEDs of the LED light source 16, so that the optical parameter(s) of the light beams emitted from the LED light source 16 achieve the expected value(s).

In particular, process (a) includes the steps of: (a1) using an image signal of the display device 10 such as a vertical synchronous signal V-sync to generate a reset signal synchronized with the V-sync; (a2) using the reset signal and a counter with a special bit length and a counting frequency to generate a reference signal synchronized with the V-sync; and (a3) using the reference signal to synchronize the PWM signals PWM_IR, PWM_IG and PWM_IB with the V-sync, so as to obtain multiple synchronized PWM signals PWM_OR, PWM_OG and PWM_OB, and thereafter outputting the synchronized PWM signals PWM_OR, PWM_OG and PWM_OB. As a result, the visible beat frequency disturbance can be effectively eliminated and thus an image quality of the display device 10 can be improved.

Process (b) includes the steps of: (b1) generating a reset signal with a special frequency; (b2) utilizing the reset signal and a counter with a special bit length and a counting frequency to generate multiple (e.g., three) reference signals having same frequency with respective different phases and synchronized with the reset signal; and (b3) using the reference signals to process the PWM signals PWM_IR, PWM_IG and PWM_IB to generate multiple PWM signals PWM_OR, PWM_OG and PWM_OB having respective different phases and synchronized with the reset signal. As such, the generation of excessive instantaneous driving current would be effectively suppressed and thus the shorten of life-span of components can be avoid and the electromagnetic interference can be reduced.

### FIRST EMBODIMENT

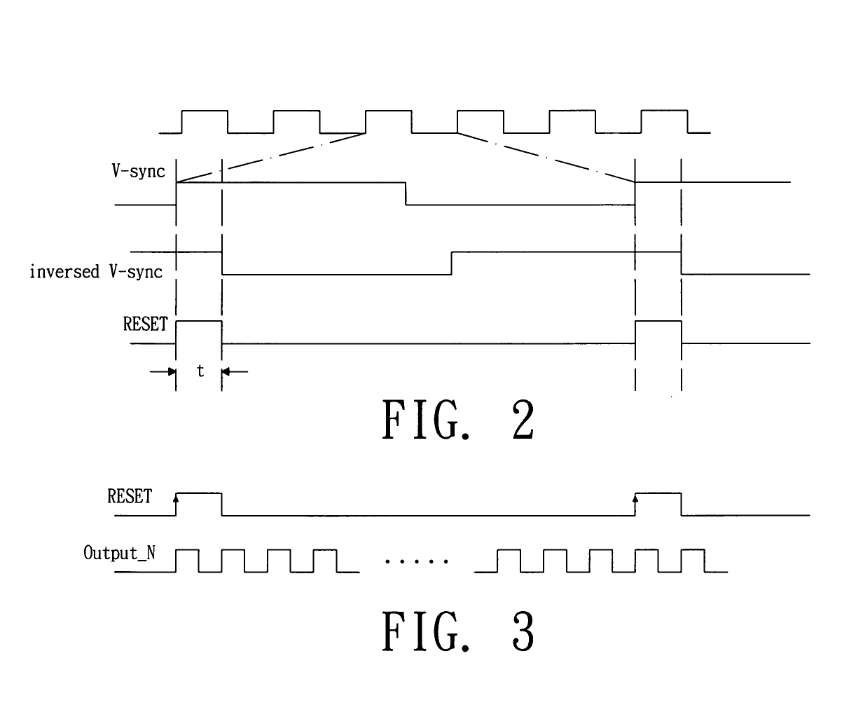

Referring to FIGS. 2 through 7, a color management process of using the color management system 12 to generate the PWM signals PWM_OR, PWM_OG and PWM_OB synchronized with an image signal, will be described below in detail. The color management process includes the following steps (1)˜(3).

(1) A reset signal RESET synchronized with an image signal of the display device 10 is generated via the advance function module 124. The display device 10 generally includes image signals, such as horizontal synchronous signal H-sync and vertical synchronous signal V-sync. In this embodiment, the reset signal RESET is generated by the use of V-sync.

In particular, referring to FIG. 2, the generation of the reset signal RESET actually is a result of several sub-steps. The V-sync is inputted into an inverter configured in the advance function module 124 so as to obtain an inversed V-sync. An inherent delay characteristic of the inverter would result in an existence of phase difference T between the inversed V-sync and the inputted V-sync. The V-sync and the inversed V-sync then are inputted into a AND gate configured in the advance function module 124. The AND gate will perform a AND Boolean operation applied to the inputted V-sync and inversed V-sync. As a result, the reset signal RESET synchronized with the V-sync is generated. In this embodiment, the reset signal RESET and V-sync are synchronous and have the same frequency.

(2) A reference signal synchronized with the image signal is generated by the use of the reset signal RESET and a counter with a special bit length and a counting frequency.

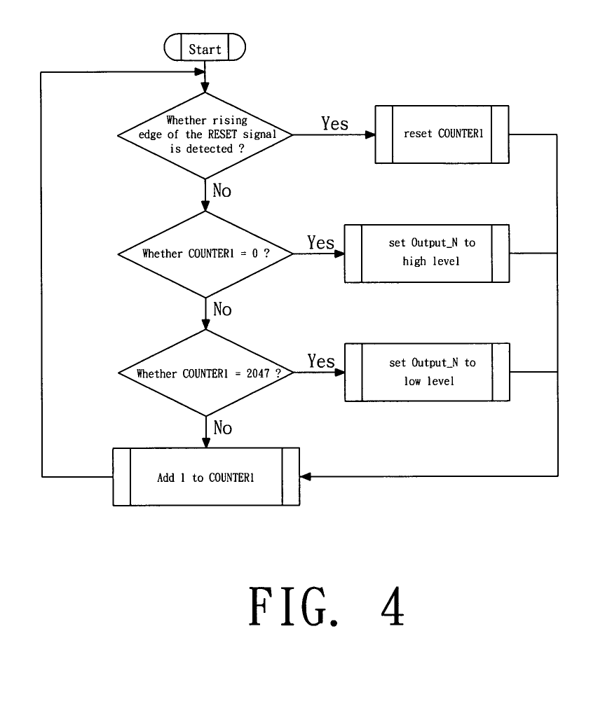

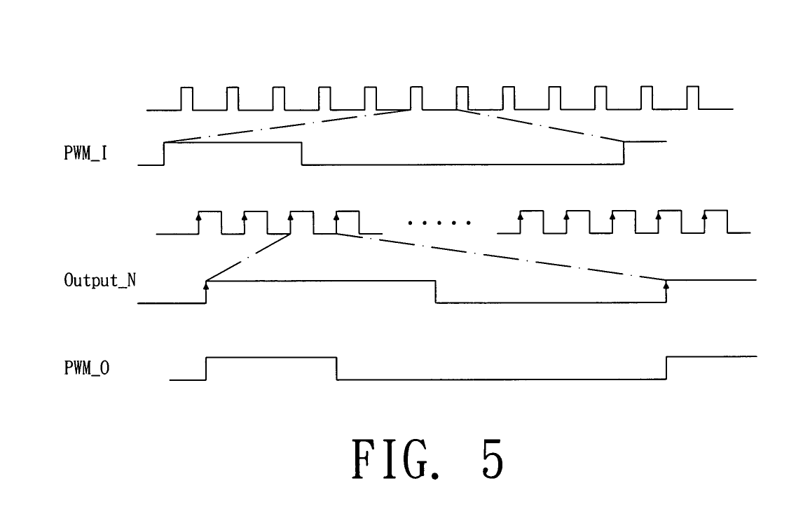

Specifically, referring to FIGS. 3 and 4, a frequency of the reference signal Output_N is positive integer times of that of the reset signal RESET (generally equal to the frequency of the V-sync). For example, when the frequency of V-sync is about 60 Hertz (Hz), the frequency of the reference signal Output_N can be set as about 600 Hz, i.e., the ten times of the frequency of the V-sync. Correspondingly, a 12-bits counter COUNTER1 can be configured in the advance function module 124 and triggered by a rising edge of the reset signal RESET to generate the reference signal Output_N synchronized with the reset signal RESET and having the frequency of about 600 Hz. A countering frequency of the 12-bits counter COUNTER1 can be set by a clock signal generated from an oscillator configured in the advance function module 124 and having an oscillating frequency of about 2.457 megahertz (MHz). Since the reset signal RESET is synchronized with the V-sync, the generated reference signal Output_N also is synchronized with the V-sync. In this situation, the calculation for the frequency of the reference signal Output_N is that: 1/(1/2457000*2¹²)=1/(1/2457000*4096)≈600 Hz. FIG. 4 shows a flow chart for generating the reference signal Output_N by the use of the 12-bits counter COUNTER1 triggered by the rising edge of the reset signal RESET, a duty circle of the generated reference signal Output_N is about 50%. It is understood that the reference signal Output_N can have any duty circle by changing the reference count value(s) of the 12-bits counter COUNTER1 for setting the reference signal Output_N as high-level and/or low-level via software program.

(3) Multiple PWM signals synchronized with the image signal are generated by using the reference signal Output_N to synchronize multiple PWM signals generated from the color management controller 122 with the image signal of the display device 10.

Particularly, referring to FIGS. 5 through 7, a duty circle of a PWM signal PWM_I (representing any one of PWM_IR, PWM_IG and PWM_IB) generated from the color management controller 122 is calculated by the use of counters COUNTER2_HIGH and COUNTER2_LOW with respective a special bit lengths and a counting frequencies. The counters COUNTER2_HIGH and COUNTER2_LOW are configured in the advance function module 124. The calculated duty circle of the PWM signal PWM_I is saved in a register, configured in the advance function module 124, as a reference count value. A counter COUNTER3 with a special bit length and a counting frequency is triggered by a rising edge of the reference signal Output_N to generate a synchronized PWM signal PWM_O (representing corresponding one of PWM_OR, PWM_OG and PWM_OB which respectively correspond to the PWM_IR, PWM_IG and PWM_IB) having the same frequency and duty circle as that of the PWM signal PWM_I. The reference count value saved in the register is employed for the counter COUNTER3 to set the duty circle of the synchronized PWM signal PWM_O. The frequency of the reference signal Output_N is the same as that of the PWM signal PWM_I, the synchronized PWM signal PWM_O is synchronized with the reference signal Output_N, i.e., synchronized with the V-sync.

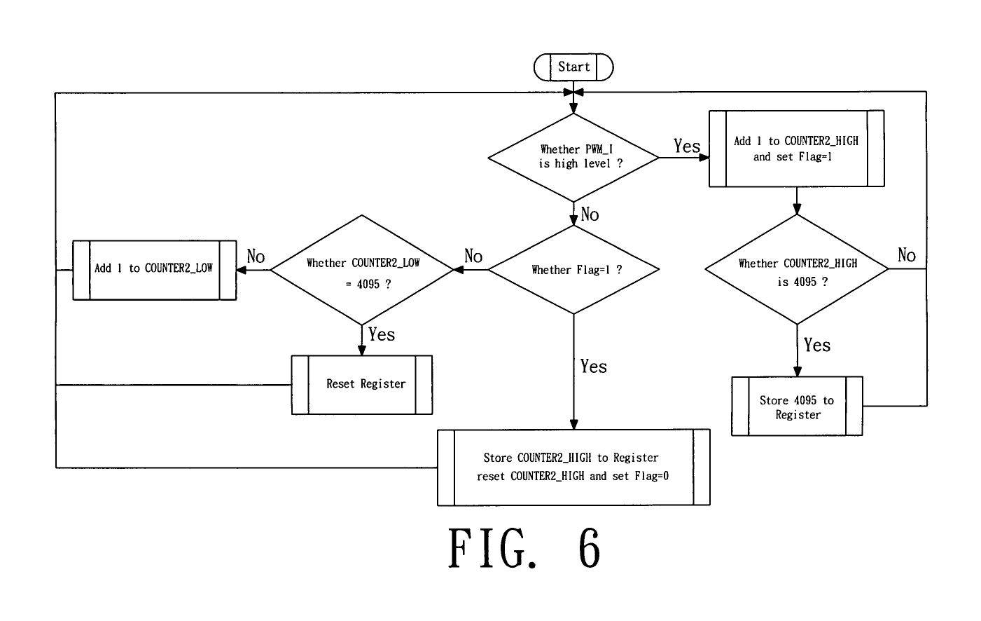

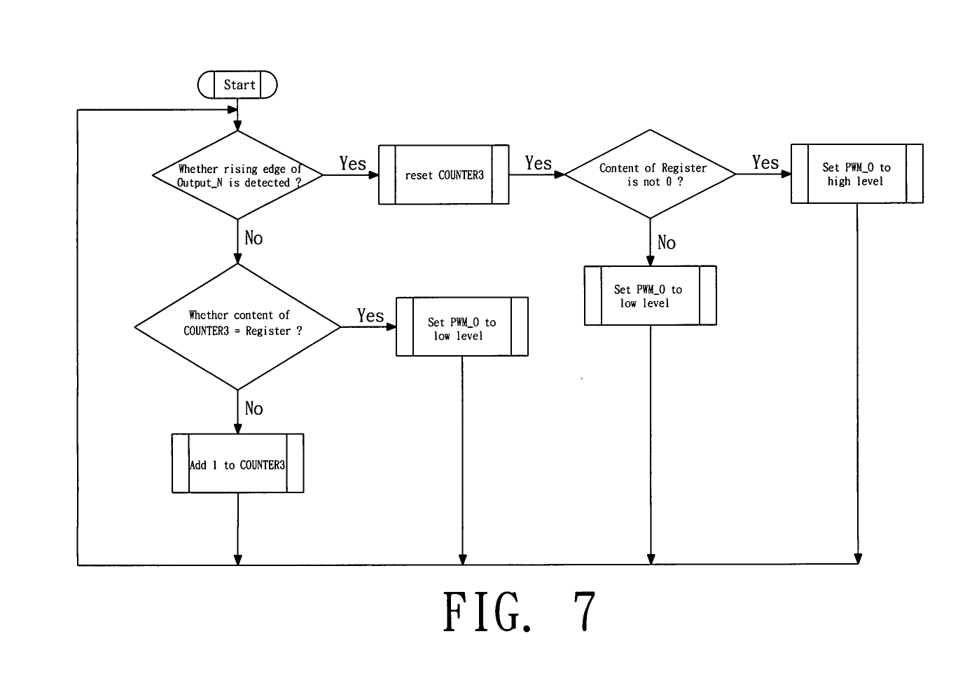

FIG. 6 shows an illustrative flow chart for calculating the duty circle of the PWM signal PWM_I by the use of 12-bits counters COUNTER2_HIGH and COUNTER2_LOW. The counting frequencies of the 12-bits counters COUNTER2_HIGH and COUNTER2_LOW can be set via an oscillator configured in the advance function module 124 and having an oscillating frequency of about 2.457 MHz. The register is configured to save a maximum count value of the 12-bits counter COUNTER2_HIGH as the reference count value. The maximum count value is corresponding to the PWM signal PWM_I at high-level in each period.

FIG. 7 shows an illustrative flow chart for generating the synchronized PWM signal PWM_O which has the same frequency and duty circle with the PWM signal PWM_I, by the use of a 12-bits counter COUNTER3 triggered by the rising edge of the reference signal Output_N. The count value saved in the register is employed for the 12-bits counter COUNTER3 to set the duty circle of the synchronized PWM signal PWM_O. The counting frequency of the 12-bit counter COUNTER3 is set by an oscillator configured in the advance function module 124 and having an oscillating frequency of about 2.457 MHz.

The color management process, in accordance with the first embodiment of the invention, utilizes the V-sync of the image signal to generate the reference signal Output_N synchronized therewith, uses the counters COUNTER2_HIGH, COUNTER2_LOW and COUNTER3 with respective the special bit lengths and counting frequencies to accurately duplicate the PWM signal PWM_I generated from the color management controller 122, and employs the rising edge of the reference signal Output_N as a trigger to make the duplicated PWM signal PWM_O to be synchronized with the V-sync. The duplicated PWM signal PWM_O is acted as the resultant output of the color management system 12. Thereafter, the driver 14 of the display device 10 can generate corresponding driving currents, according to the PWM signals PWM_O (including PWM_OR, PWM_OG and PWM_OB), to respectively control the optical characteristic(s) such as chrominance and/or luminance of the three primary color LEDs of the LED light source 16. As a result, the visible beat frequency disturbance can be effectively eliminated and thus the image quality of the display device 10 can be improved.

### SECOND EMBODIMENT

Referring to FIGS. 5 through 9, another color management process of using the color management system 12 to generate multiple (e.g., three) synchronized PWM signals PWM_OR, PWM_OG and PWM_OB with respective different phases will be described below in detail. The color management process includes the following steps (I) and (II).

(I) Multiple (e.g., three) reference signals with respective different phases and synchronized with a reset signal with a special frequency are generated by the use of the reset signal and a counter having a special bit length and a counting frequency.

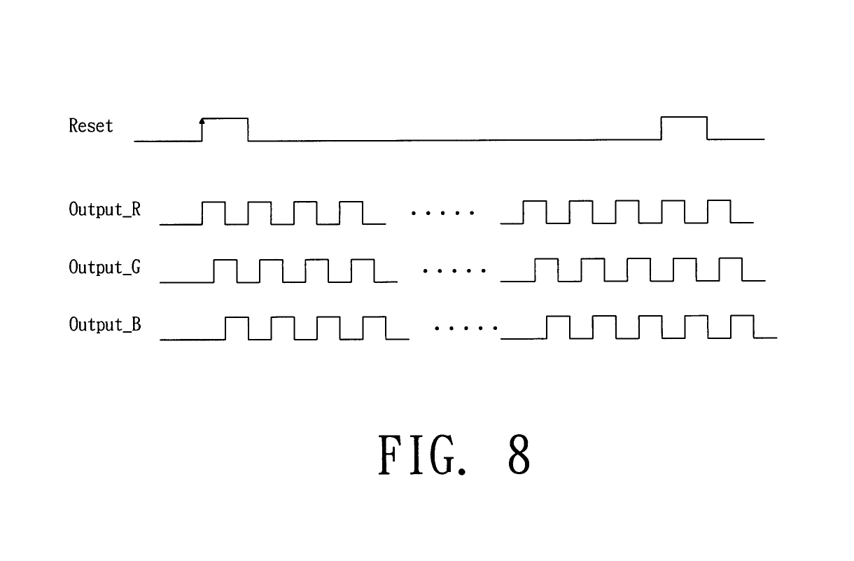

In particular, referring to FIG. 8, three reference signals Output_R, Output_G and Output_B with respective different phases and synchronized with the reset signal are generated by the use of the reset signal and the counter COUNTER1 with a special bit length and a counting frequency. The counter COUNTER1 is configured in the advance function module 124. In this embodiment, the reset signal is the same as the reset signal RESET associated with the first embodiment of the present invention as described above. A frequency of each of the reference signals Output_R, Output_G and Output_B is positive integer times of that of the reset signal RESET. For example, when the frequency of the reset signal RESET is about 60 Hz, the frequencies of the reference signals Output_R, Output_G and Output_B all can be set as about 600 Hz, i.e., ten times of the frequency of the reset signal RESET. Correspondingly, the three references signals Output_R, Output_G and Output_B with a frequency of about 600 Hz and synchronized with the reset signal RESET can be generated by the use of the 12-bits counter COUNTER1 triggered by a rising edge of the reset signal RESET. The counting frequency of the counter COUNTER1 can be set by a clock signal generated from an oscillator having an oscillating frequency of about 2.457 MHz. In this circumstance, the calculation for the frequency of each of the reference signals Output_R, Output_G and Output_B is that: 1/(1/2457000*2¹²)=1/(1/2457000*4096≈600 Hz.

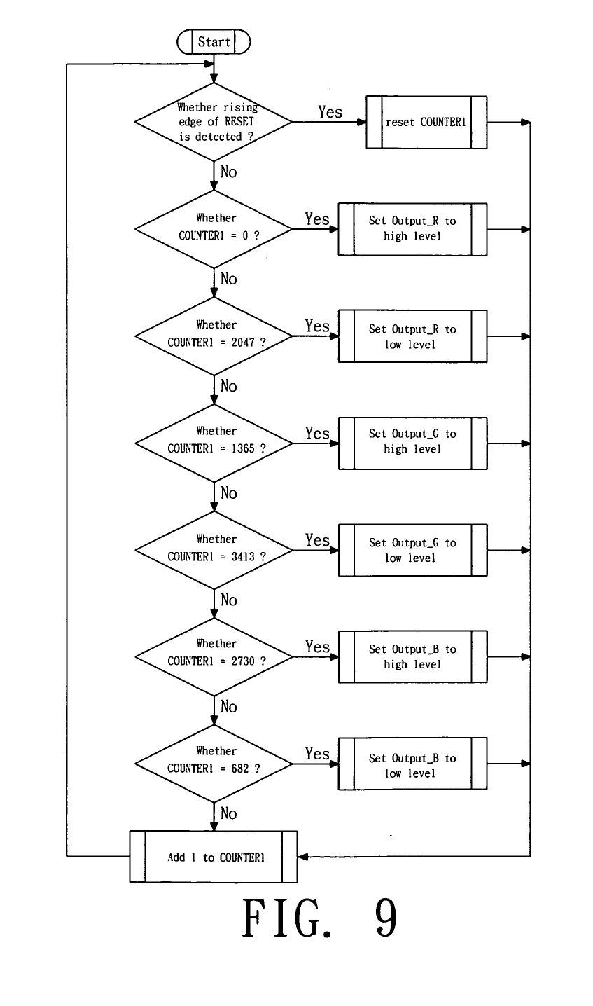

FIG. 9 shows an illustrative flow chart for generating synchronized reference signals Output_R, Output_G and Output_B by the use of the 12-bits counter COUNTER1 triggered by the rising edge of the reset signal RESET. The synchronized reference signals Output_R, Output_G and Output_B have same frequency with respective different phases. The reference signal Output_G has a 120-degree phase angle difference from the reference signal Output_R, and the reference signal Output_B has a 120-degree phase angle difference from the reference signal Output_G. It is understood that the reference signals Output_R, Output_G and Output_B can have any degree phase angle different from one another by changing the count values of the counter COUNTER1 for setting the reference signals Output_R, Output_G and Output_B as high-level via software program.

(II) Multiple synchronized PWM signals PWM_OR, PWM_OG and PWM_OB with respective different phases are generated as output by the use of the reference signals Output_R, Output_G and Output_B with respective different phases to respectively process the PWM signals PWM_IR, PWM_IG and PWM_IB which are generated from the color management controller 122. In particular, the process of using the reference signals Output_R, Output_G and Output_B to respectively process the PWM signals PWM_IR, PWM_IG and PWM_IB can be seen from FIGS. 5 through 7, what is needed is only to replace the labels of PWM_I, Output_N and PWM_O in FIGS. 5 through 7 to be PWM_IR, Output_R and PWM_OR, or PWM_IG, Output_G and PWM_OG, or PWM_IB, Output_B and PWM_OB, and thus will not be repeated herein. Since the reference signals Output_R, Output_G and Output_B have respective different phases, the PWM signals PWM_IR, PWM_IG and PWM_IB corresponding therewith will be synchronized and thereby the synchronized PWM signals PWM_OR, PWM_OG and PWM_OB with respective different phases can be generated as a result. Furthermore, the phase differences among the synchronized PWM signals PWM_OR, PWM_OG and PWM_OB are the same as that among the reference signals Output_R, Output_G and Output_B.

The color management process, in accordance with the second embodiment of the present invention, can distinguish the resultant PWM signals outputted from the color management system 12 into three synchronized PWM signals PWM_OR, PWM_OG and PWM_OB having respective different phases by the use of the reference signals Output_R, Output_G and Output_B with respective different phases and synchronized with the reset signal. Thereafter, the driver 14 of the display device 10 can generate corresponding synchronized driving currents with respective different phases, according to the synchronized PWM signals PWM_OR, PWM_OG and PWM_OB having respective different phases, to respectively control the optical characteristic(s) such as chrominance and/or luminance of three primary color LEDs of the LED light source 16. As such, the excessive instantaneous driving current can be effectively suppressed so that the shorten of life span of components can be avoid and the electromagnetic interference can be reduced. Furthermore, by using the reset signal RESET synchronized with the V-sync of the image signal as the reset signal for generating the synchronized reference signals Output_R, Output_G and Output_B, the visible beat frequency disturbance also can be effectively eliminated and thus the image quality of the display devices 10 can be improved.

In addition, it is understood that, the display device 10 in accordance with the present embodiment is not limited to using three RGB primary colors for color mixing, and correspondingly the number of the PWM signals generated from the color management system 12 is not limited to be three (i.e., the PWM_OR, PWM_OG and PWM_OB) and may be changed based upon the number of primary colors for color mixing in relation to the display device 10.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit claim scope to a special embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A color management system configured in a display device and for controlling an optical characteristic of a light source which emits different color light beams, the color management system comprising:
a color sensor for detecting a value of an optical parameter of the light beam emitted from the light source;
a color management controller for generating a plurality of pulse width modulation signals to compensate a difference between an expected value and the detected value of the optical parameter; and
an advance function module for implementing a process (a) or a process (b) applied to the pulse width modulation signals, wherein:
the process (a) comprises the steps of:
using an image signal of the display device to generate a reset signal synchronized with the image signal;
using the reset signal and a counter with a special bit length and a counting frequency to generate a reference signal synchronized with the image signal; and
using the reference signal to respectively synchronize the pulse width modulation signals with the image signal so as to obtain a plurality of synchronized pulse width modulation signals, and outputting the synchronized pulse width modulation signals;
the process (b) comprises the steps of:
generating a reset signal with a special frequency;
using the reset signal and a counter with a special bit length and a counting frequency to generate a plurality of reference signals with respective different phases and synchronized with the reset signal, the reference signals respectively corresponding to the pulse width modulation signals; and
synchronizing the pulse width modulation signals respectively with the reference signals with respective different phases so as to obtain a plurality of synchronized pulse width modulation signals with respective different phases, and outputting the synchronized pulse width modulation signals.

2. The color management system according to claim 1, wherein the reset signal in relation to the process (b) is the same as the reset signal synchronized with the image signal in relation to the process (a).

3. The color management system according to claim 1, wherein the color sensor is a three-color sensor.

4. The color management system according to claim 1, wherein the display device is selected from the group consisting of a color filter liquid crystal display device and a color filter-less field sequential liquid crystal display device.

5. The color management system according to claim 1, wherein the advance function module and the color management controller are integrated into one unit.

6. The color management system according to claim 1, wherein a frequency of the reference signal synchronized with the image signal in relation to the process (a) is approximately positive integer times of that of the image signal.

7. The color management system according to claim 6, wherein the frequency of the reference signal synchronized with the image signal in relation to the process (a) is approximately the same as that of the pulse width modulation signals generated from the color management controller.

8. The color management system according to claim 1, wherein a frequency of each of the reference signals with respective different phases in relation to process (b) is approximately positive integer times of that of the reset signal with the special frequency.

9. The color management system according to claim 8, wherein the frequency of each of the reference signals with respective different phases in relation to process (b) is approximately the same as that of the pulse width modulation signals generated from the color management controller.

10. A color management process executed in a color management system of a display device, the color management system comprising a color management controller, the color management process comprising the steps of:
using an image signal of the display device to generate a reset signal synchronized with the image signal;
using the reset signal and a counter with a special bit length and a counting frequency to generate a reference signal synchronized with the image signal; and
using the reference signal synchronized with the image signal to synchronize a plurality of pulse width modulation signals, generated from the color management controller, with the image signal, so as to obtain a plurality of synchronized pulse width modulation signals, and outputting the synchronized pulse width modulation signals.

11. The color management process according to claim 10, wherein the step of using the reference signal synchronized with the image signal to synchronize the pulse width modulation signals with the image signal comprises the sub-steps of:
using a first counter with the special bit length and the counting frequency to calculate a duty circle of a special one of the pulse width modulation signals generated from the color management controller;
employing the reference signal synchronized with the image signal to trigger a second counter with the special bit length and the counting frequency to generate a corresponding one of the synchronized pulse width modulation signals, the calculated duty circle being employed as a reference count value for the second counter to set a duty circle of the corresponding one of the synchronized pulse width modulation signals same as that of the special one of the pulse width modulation signals; and
repeating the above-described sub-steps so as to synchronize the plurality of pulse width modulation signals with the image signal.

12. The color management process according to claim 10, wherein a frequency of the reference signal synchronized with the image signal is approximately positive integer times of that of the image signal.

13. The color management process according to claim 12, wherein the image signal is a vertical synchronous signal of the display device.

14. The color management process according to claim 12, wherein the frequency of the reference signal synchronized with the image signal is approximately the same as that of the pulse width modulation signals generated from the color management controller.

15. The color management process according to claim 10, wherein the step of using the image signal of the display device to generate the reset signal synchronized with the image signal comprises the sub-steps of:
inputting the image signal into an inverter and AND gate, the inverter inversing the inputted image signal to generate an inversed image signal, the AND gate implementing an AND Boolean operation applied to the inputted image signal and the inversed image signal, and thereby the reset signal is generated.

16. A color management process executed in a color management system of a display device, the color management system comprising a color management controller, the color management process comprising the steps of:
using a reset signal with a special frequency and a counter with a special bit length and a counting frequency to generate a plurality of reference signals with respective different phases and synchronized with the reset signal; and
synchronizing a plurality of pulse width modulation (PWM) signals, generated from the color management controller, respectively with the reference signals to generate a plurality of synchronized pulse width modulation signals with respective different phases as output.

17. The color management process according to claim 16, wherein the synchronizing step comprises the sub-steps of:
using a first counter with the special bit length and the counting frequency to calculate a duty circle of a special one of the pulse width modulation signals generated from the color management controller;
employing one of the reference signals corresponding to the special one of the pulse width modulation signals and synchronized with the reset signal to trigger a second counter with a special bit length and counting frequency to generate a corresponding one of the synchronized pulse width modulation signals, the calculated duty circle being employed as a reference count value for the second counter to set a duty circle of the corresponding one of the synchronized pulse width modulation signals same as that of the special one of the pulse width modulation signals; and
repeating the above-described sub-steps so as to generate the plurality of synchronized pulse width modulation signals with respective different phases as output.

18. The color management process according to claim 16, wherein the reset signal with the special frequency is a signal synchronized with an image signal of the display device and generated by the use of the image signal.

19. The color management process according to claim 16, wherein a frequency of each of the reference signals with respective different phases is approximately positive integer times of that of the reset signal.

20. The color management process according to claim 19, wherein the frequency of each of the reference signals with respective different phases is approximately the same as that of the pulse width modulation signals generated from the color management controller.
